(19) United States
(12) Patent Application Publication
(10) Pub. No.: US 2007/0217841 A1
(43) Pub. Date: Sep. 20, 2007

(54) Image forming apparatus having fixing unit

(76) Inventor: Makoto Fujii, Tokyo (JP)

Correspondence Address: CANTOR COLBURN, LLP, 55 GRIFFIN ROAD SOUTH, BLOOMFIELD, CT, 06002, US

(21) Appl. No.: 11/646,021

(22) Filed: Dec. 27, 2006

(30) Foreign Application Priority Data
Mar. 15, 2006 (JP) JP2006-070405

(51) Int. Cl. G03G 15/20

(52) U.S. Cl. 399/341

(57) ABSTRACT

In an image forming apparatus having a fixing unit to fix a toner image onto a recording material by heating and pressing the recording material on which the toner image including a toner containing wax has been formed, at a nip portion formed among plural members, the fixing unit includes: a compressed air jetting section which jets compressed air onto the recording material which has passed the nip portion; a temperature changing section which changes a temperature of the compressed air to be jetted from the compressed air jetting section; and a temperature control section which controls the temperature of the compressed air, according to a glossiness.

This application is based on Japanese Patent Application Publication No. 2006-070405 filed on Mar. 15, 2006, which is hereby incorporated by reference.

### BACKGROUND OF THE INVENTION

The present invention relates to a fixing unit that fixes a toner image formed on a recording material by heating and pressing, and in particular, to an image forming apparatus that can change glossiness of the toner image after being fixed to the desired glossiness.

In an image forming apparatus of an electrophotographic type such as a copying machine, a printer, a facsimile machine and a multifunctional machine equipped with various functions of the aforesaid machines, a latent image corresponding to a document is formed on a photoconductor, the latent image is exposed to toner to be visualized, then, the visualized toner image is transferred onto a recording sheet, and the toner image transferred onto the recording sheet is fixed to be ejected.

As a fixing unit to fix a toner image, there is a fixing unit of a heat roller fixing type wherein a recording sheet onto which a toner image has been transferred is heated and pressed by a nipping portion formed by a heat roller that houses therein a halogen heater and a pressing roller that presses the heat roller, while the recording sheet is nipped and conveyed, and the fixing unit of this kind is widely used because its structure is simple.

Further, there is a fixing unit of a belt fixing type wherein an endless fixing belt is trained about a heat roller that houses therein a halogen heater and a fixing roller, and a pressing roller that presses the fixing roller through the fixing belt is provided, and a recording sheet onto which a toner image has been transferred is heated and pressed by a nipping portion formed by a fixing belt and a pressing roller, while the recording sheet is nipped and conveyed by the nipping portion, and the fixing unit of this kind has advantages that a warm-up period can be shortened, resulting in energy conservation.

In this case, it is desired that a high-gloss image and a low-gloss image can be obtained depending on an image and a recording sheet for image forming. That is, when forming a solid image such as a photograph or a catalog, it is preferable that a high-gloss image with 35% of glossiness or more (measuring angle 75°) is formed on a high-gloss recording sheet and, when forming a line image such as a character in a business document, it is preferable that a low-gloss image with about 25% of glossiness (measuring angle 75°) is formed on a low-gloss recording sheet.

As a method to change glossiness, there has been known a way to change nipping pressure, wherein, if the nipping pressure is made to be higher, glossiness is elevated, and if the nipping pressure is made to be lower, glossiness is lowered.

Further, there is disclosed Patent Publication concerning the image forming apparatus wherein a fixing temperature of the fixing unit is changed, and the fixing temperature is elevated when glossiness is made to be high, and the fixing temperature is lowered when glossiness is made to be low (See Japanese Patent Application Publication No. 05-19660).

Further, there is disclosed Patent Publication concerning the technology wherein two belts are arranged on the downstream side of the fixing unit to nip the recording sheet after fixing and a belt on one side is cooled by a heat sink, to prevent that fused toner after fixing surges in the course of natural cooling, and fine swells are caused. Owing to this, fused toner is pressed, during a period until the fused toner is solidified, by the belt surface which is flat, so that the state of a toner image surface is caused to follow the state of the belt surface, and a gloss of a toner image is adjusted (See Japanese Patent Application Publication No. 2004-325934).

In the prior art, there is a problem that separation of a recording sheet is worsened when nipping pressure of a fixing unit is enhanced for the purpose of elevating glossiness.

Further, in Japanese Patent Application Publication No. 05-19660, it is feared that fixing failure is caused, when a fixing temperature is lowered for the purpose of lowering glossiness.

In Japanese Patent Application Publication No. 2004-325934, there is a problem that an apparatus grows in size and the cost of the apparatus is increased, because exclusive two belts and a cooling means need to be arranged on the downstream side of a fixing unit.

### SUMMARY OF THE INVENTION

The present invention has been achieved in view of the problems stated above, and its objective is to provide an image forming apparatus wherein a desired image having high glossiness or low glossiness can be obtained in a simple structure.

The aforesaid objective is attained by the structures described below.

The image forming apparatus of the invention is represented by an image forming apparatus equipped with a fixing unit that heats and presses a recording material on which a toner image formed with toner containing wax is formed at a nipping portion formed between plural members, and thereby, fixes the aforesaid toner image on the recording material, wherein there are provided a compressed air jetting section that jets compressed air to the recording material that has passed the nipping portion, a temperature changing section that changes a temperature of compressed air jetted from the compressed air jetting section and a temperature control section that changes a temperature of the aforesaid compressed air, depending on glossiness.

### BRIEF DESCRIPTION OF THE DRAWINGS

FIG. 1 is a structural diagram of an image forming apparatus.

FIG. 2 is a cross-sectional view of a fixing unit.

FIG. 3 is a perspective view of an air nozzle.

FIG. 4 is a flow chart for changing a temperature of compressed air.

FIG. 5 is a block diagram for changing a temperature of compressed air.

FIG. 6 is a cross-sectional view of a fixing unit equipped with an air nozzle that jets compressed air in two directions.

FIG. 7 is a cross-sectional view of a fixing unit of a belt fixing type.

### DETAILED DESCRIPTION OF THE PREFERRED EMBODIMENT

An embodiment relating to the image forming apparatus of the invention will be explained as follows, referring to the drawings.

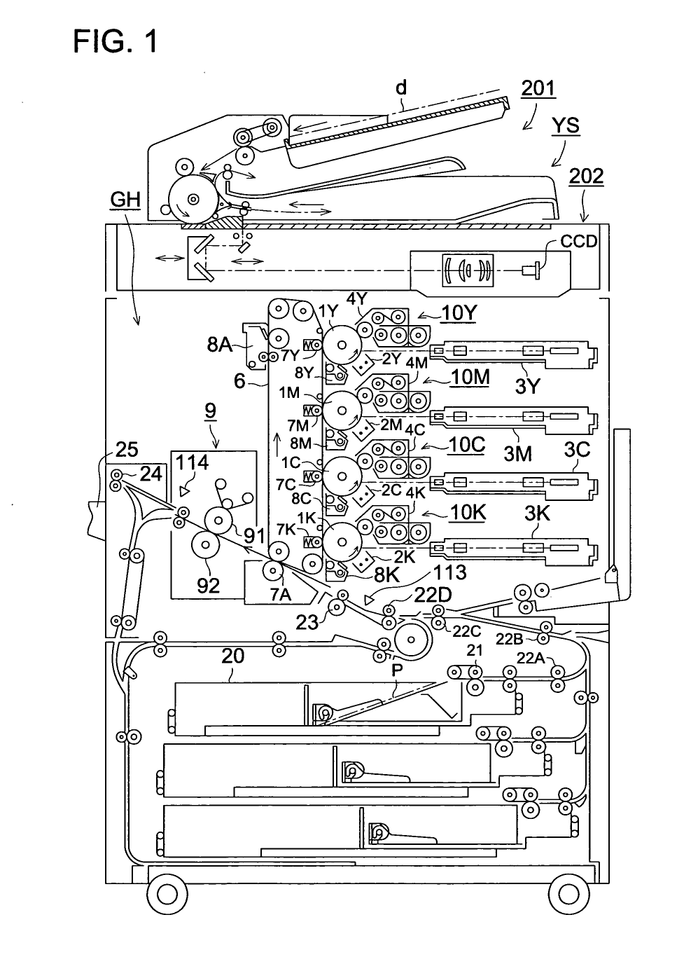

First, an example of the image forming apparatus will be explained based on the structural diagram in FIG. 1.

The present image forming apparatus is composed of image forming apparatus main body GH and image reading section YS.

The image forming apparatus main body GH is one called a tandem type color image forming apparatus, and it is composed of plural sets of image forming sections 10Y, 10M, 10C and 10K, belt-shaped intermediate transfer member 6, a sheet feed conveyance section and fixing unit 9.

On the upper portion of the image forming apparatus main body GH, there is provided image reading section YS that is composed of automatic document feeder 201 and document image scanning exposure unit 202. Document d placed on a document stand of the automatic document feeder 201 is conveyed by a conveyance section, and then, images on one side or two sides of the document are scanned for exposure by an optical system of the document image scanning exposure unit 202, to be read into line image sensor CCD.

Signals formed through photoelectric conversion conducted by the line image sensor CCD are sent to exposure sections 3Y, 3M, 3C and 3K, after being subjected to analog processing, A/D conversion, shading correction and image compression processing, in an image processing section.

In the image forming sections 10Y for forming a yellow (Y) image, charging unit 2Y, exposure unit 3Y, developing unit 4Y and cleaning unit 8Y are arranged around photoconductor drum 1Y. In the image forming sections 10M for forming a magenta (M) image, charging unit 2M, exposure unit 3M, developing unit 4M and cleaning unit 8M are arranged around photoconductor drum 1M. In the image forming sections 10C for forming a cyan (C) image, charging unit 2C, exposure unit 3C, developing unit 4C and cleaning unit 8C are arranged around photoconductor drum 1C. In the image forming sections 10K for forming a black (K) image, charging unit 2K, exposure unit 3K, developing unit 4K and cleaning unit 8K are arranged around photoconductor drum 1K. A combination of charging unit 2Y and exposure unit 3Y, a combination of charging unit 2M and exposure unit 3M, a combination of charging unit 2C and exposure unit 3C and a combination of charging unit 2K and exposure unit 3K constitute a latent image forming device.

Incidentally, developing unit 4Y includes two-component developer composed of yellow (Y) small-particle-sized toner and carrier, developing unit 4M includes two-component developer composed of magenta (M) small-particle-sized toner and carrier, developing unit 4C includes two-component developer composed of cyan (C) small-particle-sized toner and carrier, and developing unit 4K includes two-component developer composed of black (K) small-particle-sized toner and carrier.

Toner in this case contains wax for the purpose to cause the fixing unit to be oilless, and to improve a revising property for recording sheet (recording material) P.

Intermediate transfer member 6 is trained about a plurality of rollers, and is supported rotatably.

Fixing unit 9 fixes a toner image on recording sheet P by heating and pressing the toner image at the nipping portion formed between heated heat roller 91 and pressing roller 92.

In this way, images each having each of respective colors formed respectively by image forming sections 10Y, 10M, 10C and 10K are transferred successively on rotating intermediate transfer member 6 respectively by transfer units 7Y, 7M, 7C and 7K (primary transfer), and a toner image wherein color images are composed is formed. Recording sheet P loaded in sheet feed cassette 20 is fed by sheet feed section 21, and then, passes through sheet feed rollers 22A, 22B, 22C, 22D and registration roller 23 to be conveyed to transfer section 7A, and a color image is transferred onto recording sheet P (secondary transfer). The recording sheet P onto which a color image has been transferred is heated and pressed at the fixing unit 9, and a color toner image on the recording sheet P is fixed. After that, the recording sheet P is nipped by sheet ejection rollers 24 to be ejected on sheet ejection tray 25 located outside the apparatus.

On the other hand, after the color image has been transferred onto recording sheet P by transfer section 7A, the intermediate transfer member 6 from which the recording sheet P is curvature-separated is cleaned by cleaning device 8A so that residual toner is removed.

In the meantime, what has been explained above is an image forming apparatus that forms a color image. However, it may also be an image forming apparatus that forms a monochromatic image, and an intermediate transfer member may either be used or it may not be used.

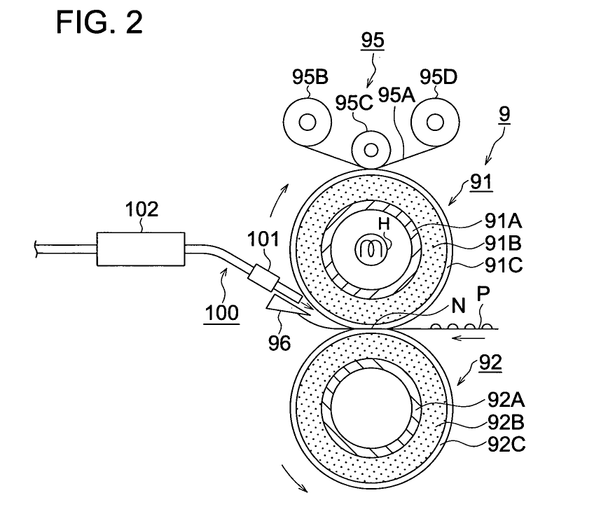

Next, a fixing unit relating to the invention will be explained based on a cross-sectional view in FIG. 2.

In FIG. 2, fixing unit 9 is composed of heat roller 91 and pressing roller 92 that presses the heat roller 91 upward.

The heat roller 91 is composed of halogen heater H housed in the central part of the heat roller, core metal tube 91A that is made of aluminum or iron to be cylindrical, heat-resisting elastic layer 91B made of silicone rubber or fluorine-based rubber, and releasing layer 91C that is formed with fluorine-based resin such as PFA (perfluoroalkoxy) or PTFE (polytetrafluoroethylene) and is coated on the elastic layer 91B or covers the elastic layer 91B in a form of a tube.

Pressing roller 92 is composed of core metal tube 92A that is made of stainless steel or the like to be cylindrical,

elastic layer 92B that is made of foamed silicone rubber and is located on the outer circumferential surface of the core metal tube 92A and releasing layer 92C that is formed with PFA tube and covers the outer circumferential surface of the elastic layer 92B. The pressing roller 92 is urged by an unillustrated urging member to press the heat roller 91 upward from the lower side.

In the meantime, an induction heating method may also be employed in place of halogen heater H under some circumstances, as a heating member that heats the heat roller 91.

There is further provided cleaning device 95 that removes toner sticking to the heat roller 91, and the cleaning device 95 is composed of web 95A, web-supply core 95B around which web 95A before use is wound, pressure contact roller 95C that presses web 95A against the heat roller 91 and web take-up core 95D that takes up web 95A after use. The web 95A is made of nonwoven cloth, and it is taken up intermittently every prescribed number of sheets which have passed.

In the aforesaid structure, when heat roller 91 that is heated by halogen heater H and is driven by an unillustrated motor rotates clockwise, pressing roller 92 rotates counterclockwise. Therefore, recording sheet P on which a toner image has been formed by an image forming apparatus like that shown in FIG. 1 is nipped and conveyed by nipping portion N formed by heat roller 91 and pressing roller 92, and the toner image is fixed, when it is heated and conveyed, on the recording sheet P.

In this case, for the purpose of preventing that a toner image on recording sheet P makes pressure contact with a surface of heat roller 91, and the recording sheet P is wound around the heat roller 91 by adhesion of softened toner, there is provided compressed air jetting section 100 wherein compressed air is jetted against heat roller 91 and thereby a leading edge of the recording sheet P wound around the heat roller 91 is separated by wind pressure of the compressed air, and air nozzle 101 jetting compressed air is provided on the sheet ejection side separately placed from nipping portion N.

At a point in time when recording sheet P passes through the nipping portion N, compressed air is jetted from air nozzle 101 to separate a leading edge of recording sheet P wound around heat roller 91 from it.

Further, since guide member 96 is provided to be protruded from air nozzle 101 in the direction toward the nipping portion N, the recording sheet P thus separated is conveyed along the guide member 96 without touching the air nozzle 101.

Incidentally, since recording sheet P slides on guide member 96, it is preferable that a sliding surface on the guide member 96 is formed to be a smooth surface, and a releasing layer is coated on the sliding surface.

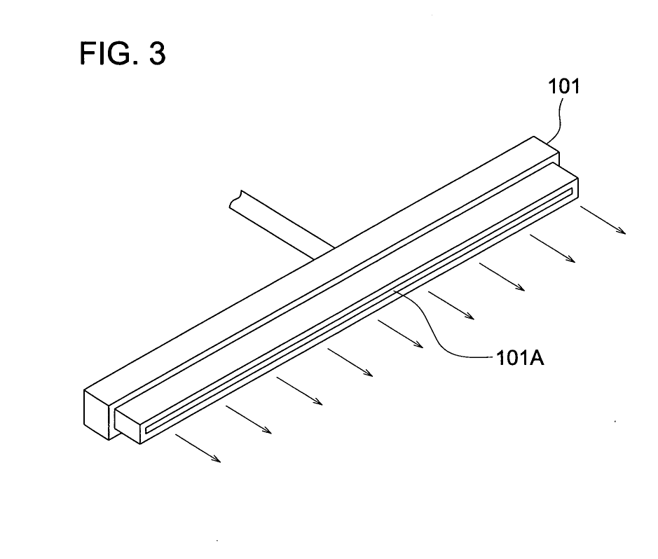

Further, as shown in a perspective view of FIG. 3, air nozzle 101 has horizontally long opening 101A that jets compressed air, and an across-the-width length of the opening 101A is greater than a crosswise length of each of heat roller 91 and pressing roller 92.

In the image forming apparatus constituted as stated above, various types of recording sheets are loaded, and various types of images are formed. It is therefore desired that images having high glossiness and low glossiness can be obtained depending on images to be formed and on recording sheets. Namely, when forming a solid image such as a photograph or a catalog, it is preferable that a high-gloss image with 35% of glossiness or more (measuring angle 75°) is formed on a high-gloss recording sheet and, when forming a line image such as a character in a business document, it is preferable that a low-gloss image with about 25% of glossiness (measuring angle 75°) is formed on a low-gloss recording sheet.

Since wax is contained in toner used for the present image forming apparatus for the purpose of improving recording performance of a recording sheet by causing toner to be oilless, it is possible to change glossiness by changing conditions for solidifying wax.

That is, when toner at high temperature is cooled rapidly, wax is solidified while it is keeping its amorphous (noncrystalline) state, resulting in high glossiness. On the other hand, when toner at high temperature is cooled slowly, wax is crystallized, resulting in low glossiness.

Accordingly, when an image with high glossiness is desired, a recording sheet after fixing may be controlled to be cooled rapidly in terms of temperature, while, when an image with low glossiness is desired, a recording sheet after fixing may be controlled to be cooled slowly in terms of temperature, and this aim can be attained by changing a temperature of compressed air to be jetted from air nozzle 101.

Therefore, as shown in FIG. 2, heating unit 102 (a temperature changing section) that heats compressed air up to prescribed temperature may be arranged in the vicinity of air nozzle 101, and a temperature of the heating unit 102 may be controlled depending on operations for setting glossiness.

There have been made experiments to confirm how glossiness is changed when a temperature of compressed air is changed, and results of the experiments are shown below.

### (1) Conditions of Experiments

Heat roller: Outside diameter 65 mm

Pressing roller: Outside diameter 55 mm

Fixing temperature: 160° C.

Compressed air temperature: 50° C., 160° C.

Fixing speed: 200 mm/sec

Toner: Wax-containing toner

Recording sheet: Coated paper POD128 with high glossiness, Non-coated paper CF80 with low glossiness

### (2) Results of Experiments

Table 1 shows results of the experiments.

TABLE 1

| Compressed air temperature | 50° C. | 160° C. |
|---|---|---|
| Recording sheet | Coated paper | Non-coated paper |
| Glossiness | 35% | 25% |

Meanwhile, glossiness was measured pursuant to JIS-Z8741 (mirror plane glossiness-measuring method), and measuring angle 75° was used for measurement.

Further, as wax to be contained in toner, it is possible to use paraffin-based wax, polyolefin-based wax, oxide of these wax and graft-processed substance, higher fatty acid, metallic salt of higher fatty acid, and commonly known wax such as amide wax of higher fatty acid and ester-based wax of higher fatty acid, and in particular, ester-based wax of higher fatty acid is preferable. Owing to this, wax diffusion from a toner image at a nipping portion is improved, and it is possible to control generation of twisting (rolling in) of an offset and a recording sheet, and to prevent uneven gloss because wax can be wiped off more skillfully.

In addition, it is possible to adjust the content of wax easily by using polymerization toner. This polymerization toner is generated by an emulsion polymerization method, and wax is higher-fatty-acid-based wax whose content is 7-23% by mass. Its softening point is about 120° C. when the content is about 13% by mass and its melting point is about 80° C. Incidentally, the softening point is measured by using a descending type flow tester, and a melting point is a peak temperature showing the maximum endotherm on a DSC curve in the course of temperature rise in a differential scanning calorimetry.

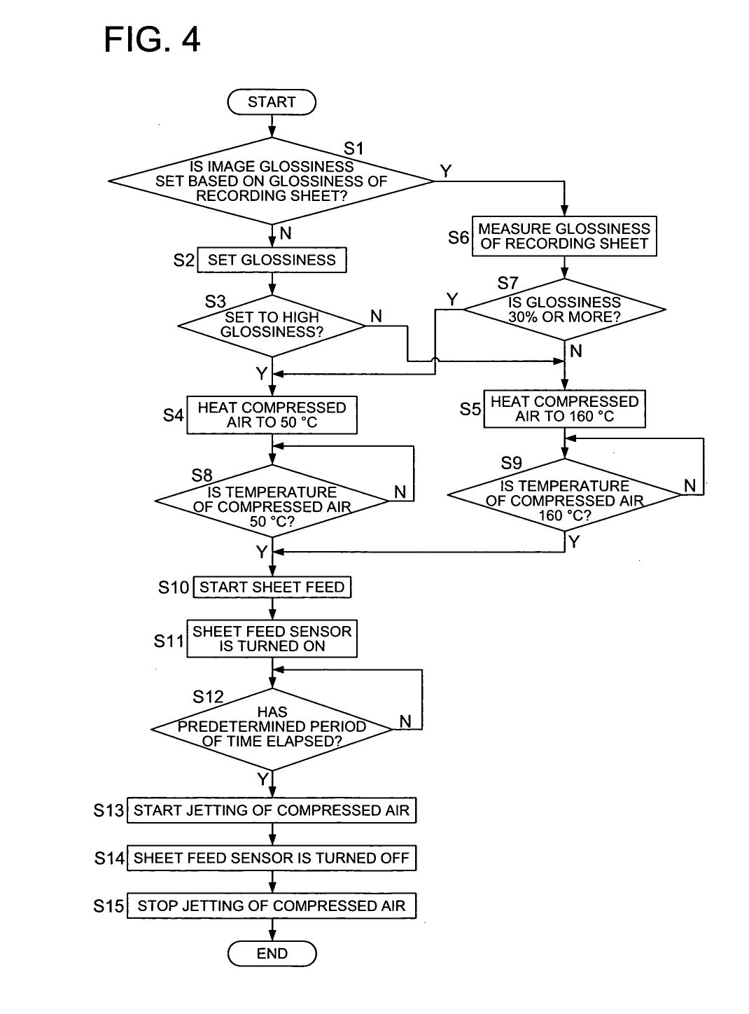

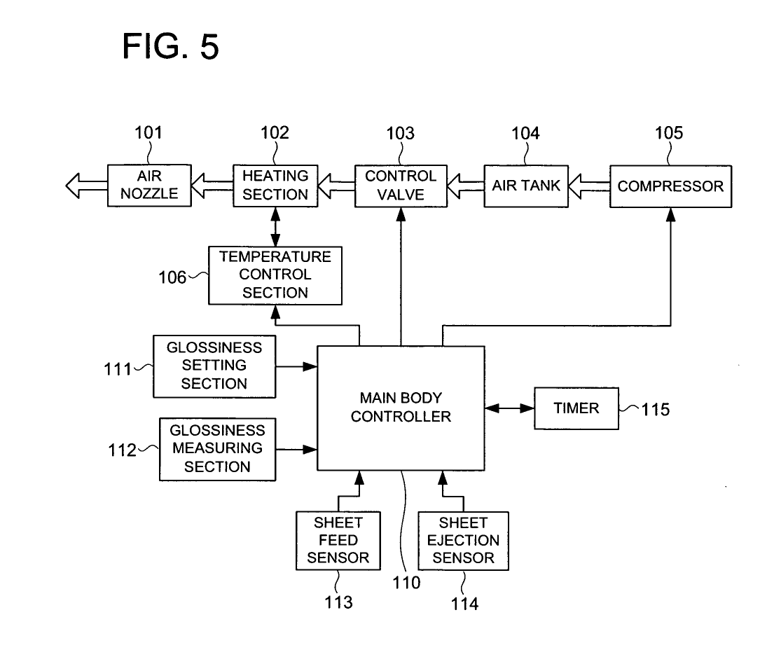

Next, there will be explained the constitution for changing a temperature of compressed air in accordance with glossiness setting operations, referring to the flow chart in FIG. 4 and the block diagram in FIG. 5, plus FIG. 1 and FIG. 2.

In FIG. 4 and FIG. 5, an operator judges whether to use glossiness of a recording sheet or not for setting glossiness of an image to be outputted to high glossiness or low glossiness (S1), and when glossiness of the recording sheet is not used for setting (N for S1), glossiness setting section 111 provided on an operation panel of an image forming apparatus is used for setting glossiness S2). When the high glossiness has been set (Y for S3), main body controller 110 composed of CPU or the like to which the signal of the setting of the high glossiness controls a temperature of heating section 102 through temperature control section 106, to heat compressed air to the temperature of 50° C., for example (S4). When the low glossiness has been set (N for S3), the main body controller 110 controls a temperature of heating section 102 through temperature control section 106, to heat compressed air to the temperature of 160° C., for example (S5).

Meanwhile, the heating section 10 is composed of a halogen heater, a ceramic heater or a heating wire.

A temperature of compressed air to be set that is 50° C. or 160° C. is just an example, and it varies depending on various conditions of the image forming apparatus including a fixing unit, exemplifying that an ordinary temperature can serve as a temperature of compressed air in the case of high glossiness in some cases. In this case, the compressed air is not heated.

On the other hand, when an operator sets glossiness of images to be outputted whether to high glossiness or to low glossiness based on glossiness of a recording sheet (Y for S1), the glossiness of the recording sheet is measured automatically by glossiness measuring section 112 (S6), and when the glossiness is measured to be, for example, 30% or higher (Y for S7), compressed air is heated to the temperature of 50° C., for example, as stated above (S4). Further, when the glossiness is measured to be less than 30% for example (N for S7), compressed air is heated to the temperature of 160° C., for example, as stated above (S5).

Then, when the temperature of compressed air arrives at a predetermined temperature of 50° C. (Y for S8) or 160° C. (Y for S9), image forming becomes possible, whereby, image forming is started and sheet feeding for recording sheet P is started by an operation of pressing a start button (S10). Then, sheet feed sensor 113 shown in FIG. 1 detects a leading edge of recording sheet P to be turned on (s11), thus, timer 115 starts counting time, and a prescribed time period up to the moment when a leading edge of recording sheet P passes through nipping portion N of fixing unit is measured. Then, after a prescribed time period has elapsed (Y for S12), control valve 103 composed of an electromagnetic valve is opened to jet compressed air at prescribed temperature from air nozzle 101 to separate a leading edge of recording sheet P wound around heat roller 91 from the heat roller 91, and compressed air at low temperature or at high temperature is jetted against total recording sheet P to be conveyed, to cool the recording sheet P rapidly or slowly (S13). Then, when sheet ejection sensor 114 arranged at the downstream side of fixing unit 9 detects a trailing edge of recording sheet P to be turned off (S14), control valve 103 is closed to stop jetting of compressed air (S15).

Further, compressed air is reserved in air tank 104 from compressor 105, then is heated up to a prescribed temperature by heating section 102 after opening of control valve 103, and is jetted from air nozzle 101.

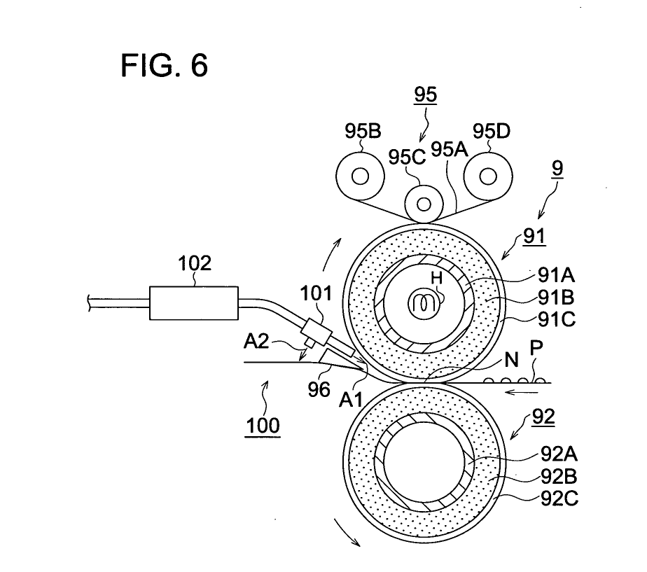

The air nozzle stated above is used for jetting compressed air in only one direction for exfoliation, quick cooling and slow cooling of recording sheet P. However, it is also possible to provide, on the air nozzle, two types of nozzles to jet compressed air in two directions, so that recording sheet P is exfoliated by compressed air jetted toward a leading edge of recording sheet P from a nozzle on one side, and the recording sheet is cooled rapidly or cooled slowly by compressed air jetted against the surface of recording sheet P from a nozzle on the other side. This structure is shown in FIG. 6. In air nozzle 101 in FIG. 6, under the assumption that A1 represents jetting toward a leading edge of recording sheet P, and A2 represents jetting toward a surface of the recording sheet, A1 may be stopped after exfoliation is finished. Further, jetting pressure of A2 may be ½ to ⅓ of jetting pressure for A1.

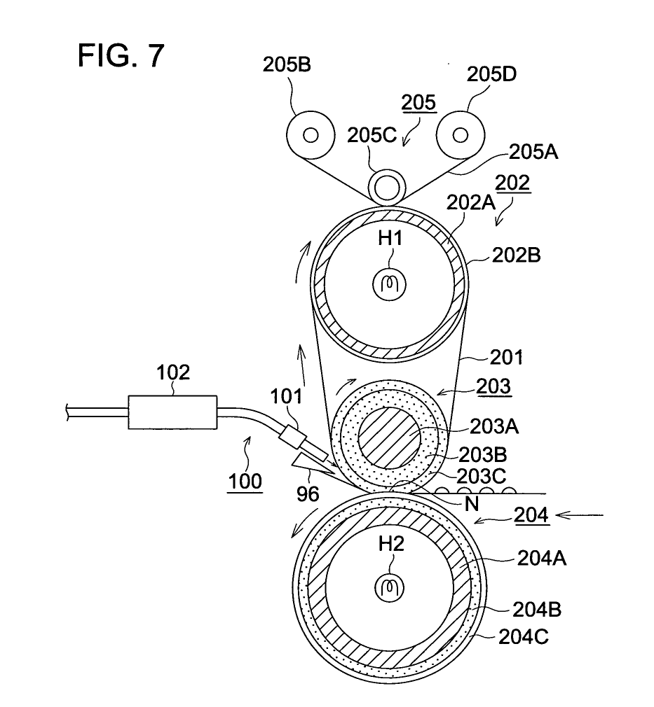

The invention is not limited to the fixing unit of a heat roller fixing type shown in FIG. 1, FIG. 2 and FIG. 6, and it may also be applied to a fixing unit of a belt fixing type as in FIG. 7. An example of the fixing unit of a belt fixing type employing the present invention will be explained as follows, referring to FIG. 7.

Fixing belt 201 is formed to be endless, and for example, a heat-resisting resin belt made of PI (polyimide) is used as a substrate, and an outer circumferential surface of the substrate is covered by heat-resisting silicone rubber, and is further covered by PFA (perfluoroalkoxy) tube as a releasing layer.

Heat roller 202 houses therein halogen heater H1 representing a heating member that heats fixing belt 201, and for example, an outer circumferential surface of cylindrical hollow rotational body 202A made of, for example, aluminum is covered by heat-resisting PFA tube 202B, to be constituted as a hard roller.

Fixing roller 203 is constituted to be a soft roller wherein solid core metal 203A made of metal such as iron is covered by heat-resisting silicone rubber 203B, and is further covered by sponge 203C.

Pressing roller 204 is constituted to be a soft roller wherein a halogen heater H2 is housed, and an outer circumferential surface of cylindrical hollow rotational body 204A made of, for example, aluminum is covered by heat-resisting silicone rubber 204B, and is further covered by PFA (perfluoroalcoxy) tube 204C representing a releasing layer.

Meanwhile, any type of heating member may be used as a heating member that heats fixing belt 201, and an induction heating heat generator employing an exciting coil, for example, may also be used. Further, a heating member does not always need to be arranged inside heat roller 202, and it can be arranged at any place.

There is further provided cleaning device 205 that removes toner sticking to fixing belt 201, and the cleaning device 205 is composed of web 205A, web-supply core 205B around which web 205A before use is wound, pressure contact roller 205C (hollow roller) that presses web 205A against the fixing belt 201 on heat roller 202, and web take-up core 205D that takes up web 205A after use. The web 205A is made of nonwoven cloth, and it is taken up intermittently every prescribed number of sheets which have passed.

In the aforesaid structure, when fixing roller 203 is rotated clockwise by an unillustrated driving section, fixing belt 201 and heat roller 202 rotate clockwise, while, pressing roller 204 rotates counterclockwise. Further, since heat roller 202 is heated by halogen heater H1, fixing belt 201 that comes in contact with heat roller 202 is also heated, and pressing roller 204 is also heated by halogen heater H2. Since the pressing roller 204 is urged by an unillustrated urging device toward fixing roller 203, recording sheet P which has been fed is heated and pressed, and a toner image on the recording sheet P is fixed at nipping portion N formed between fixing belt 201 wound around fixing roller 203 and pressing roller 204.

In the same way as in the fixing unit of a heat roller fixing type in FIG. 2, air nozzle 101 that jets compressed air and heating section 102 that heats compressed air are provided at the recording sheet P ejection side for the nipping portion N, whereby, recording sheet P is exfoliated by compressed air, and recording sheet P is cooled rapidly of slowly depending on the desired glossiness.

It is naturally possible in the fixing unit of a belt fixing type to jet compressed air in two direction as shown in FIG. 6, to exfoliate recording sheet P with jetting on one side, and to cool a recording sheet rapidly or slowly with jetting on the other side.

By the fixing unit shown above, desired images such as high-gloss images and low-gloss images are obtained by a simple and compact construction.

What is claimed is:

1. An image forming apparatus having a fixing unit to fix a toner image onto a recording material by heating and pressing the recording material on which the toner image including a toner containing wax has been formed, at a nip portion formed among plural members, the fixing unit comprising:
(a) a compressed air jetting section which jets compressed air onto the recording material which has passed the nip portion;
(b) a temperature changing section which changes a temperature of the compressed air to be jetted by the compressed air jetting section; and
(c) a temperature control section which controls the temperature of the compressed air, according to a glossiness.

2. The image forming apparatus of claim 1, further comprising:
a glossiness setting section which enables an operator to set a glossiness of the toner image,
wherein the temperature changing section changes the temperature of the compressed air according to the glossiness of the toner image set by the glossiness setting section.

3. The image forming apparatus of claim 1, wherein the temperature changing section changes the temperature of the compressed air according to a glossiness of the recording material.

4. The image forming apparatus of claim 3, further comprising a glossiness measuring section which measures the glossiness of the recording material.

5. The image forming apparatus of claim 1, wherein the temperature changing section controls a temperature of the compressed air so that the temperature for a high-gloss toner image becomes lower than that for a low-gloss toner image.

6. The image forming apparatus of claim 1, wherein the compressed air jetting section comprises an air nozzle through which the compressed air is jetted toward a leading edge of the recording material.

7. The image forming apparatus of claim 6, wherein the nip portion comprises a heating member and a pressing member, and the compressed air jetting section separates the leading edge of the recording material from the heating member by applying wind pressure of the compressed air.

8. The image forming apparatus of claim 1, wherein the compressed air jetting section comprises an air nozzle through which the compressed air is jetted, and the air nozzle has two types of jetting outlets that have jetting directions different from each other, so that one of the jetting outlets jets compressed air toward a leading edge of the recording material and the other of the jetting outlets jets compressed air toward a surface portion of the recording material.
